(19) United States
(12) Patent Application Publication
(10) Pub. No.: US 2023/0238510 A1
(43) Pub. Date: Jul. 27, 2023

(54) SOLID SECONDARY BATTERY, SOLID SECONDARY BATTERY MODULE COMPRISING SOLID SECONDARY BATTERY, AND CHARGING METHOD THEREOF

(71) Applicant: Samsung Electronics Co., Ltd., Suwon-si (KR)

(72) Inventors: Nobuyoshi YASHIRO, Yokohama-shi (JP); Shoichi SUGATA, Yokohama-shi (JP)

(21) Appl. No.: 17/949,365

(22) Filed: Sep. 21, 2022

(30) Foreign Application Priority Data
Jan. 26, 2022 (JP) 2022-010400
Mar. 21, 2022 (KR) 10-2022-0034942

(51) Int. Cl. H01M 4/134; H01M 10/0562; H01M 4/505; H01M 4/525; H01M 10/0525; H01M 4/62

(52) U.S. Cl. CPC H01M 4/134; H01M 10/0562; H01M 4/505; H01M 4/525; H01M 10/0525; H01M 4/625; H01M 2004/021

(57) ABSTRACT

A solid secondary battery includes: a positive electrode; a negative electrode; and a solid electrolyte disposed between the positive electrode and the negative electrode, wherein the negative electrode includes a negative electrode current collector, and a negative active material layer between the negative electrode current collector and the solid electrolyte, the negative active material layer includes a particulate carbon and a negative active material that forms an alloy or a compound with lithium, a content of the negative active material per unit area of the negative active material layer is about 0.01 milligram per square centimeter or to about 1 milligram per square centimeter, and a film strength of the negative active material layer is about 50 megapascals to about 250 megapascals.

### CROSS-REFERENCE TO RELATED APPLICATIONS

This application is based on and claims priority to Japanese Patent Application No. 2022-010400, filed on Jan. 26, 2022, in the Japanese Patent Office and Korean Patent Application No. 10-2022-0034942, filed on Mar. 21, 2022, in the Korean Intellectual Property Office, and all the benefits accruing therefrom under 35 U.S.C. § 119, the contents of both of which are incorporated herein in their entireties by reference.

### BACKGROUND

### 1. Field

The present disclosure relates to a solid secondary battery, a solid secondary battery module including the same, and a charging method thereof.

### 2. Description of the Related Art

The specific capacity (capacity per unit mass) of lithium is about 10 times higher than the specific capacity of graphite, which has been used as a negative active material in the art, and therefore a thin-film high-capacity solid secondary battery using lithium as a negative active material has been proposed.

In such a solid secondary battery, lithium deposited in the negative electrode during charge is eluted as lithium ions during discharge, and thus, pores are formed in the negative electrode. Therefore, as charging and discharging of the solid lithium secondary battery are repeated, the negative electrode may be damaged, which may greatly deteriorate battery performance.

To suppress the generation of pores in the negative electrode and avoid damage to the negative electrode, high external pressure has been applied by placing the solid lithium-ion secondary battery between end plates in the thickness direction.

However, the end plates for applying external pressure to the solid secondary battery can be heavy, and thus may interfere with enhancement of the overall specific energy of a battery module including the solid secondary battery and the end plates. Thus, there remains a need for improved materials that avoid the need for high external pressure.

### SUMMARY

The present disclosure is made in consideration of the above issues, and provide a solid secondary battery that may be charged/discharged without applying high external pressure.

Additional aspects will be set forth in part in the description which follows and, in part, will be apparent from the description, or may be learned by practice of the presented embodiments of the disclosure.

The solid secondary battery related to the present disclosure includes a positive electrode; a negative electrode; and a solid electrolyte disposed between the positive electrode and the negative electrode, wherein the negative electrode includes a negative electrode current collector, and a negative active material layer between the negative electrode current collector and the solid electrolyte, the negative active material layer includes a particulate carbon and a negative active material that forms an alloy or a compound with lithium, a content of the negative active material per unit area of the negative active material layer is about 0.01 milligram per square centimeter to about 1 milligram per square centimeter, and a film strength of the negative active material layer is about 50 megapascals to about 250 megapascals.

According to the solid secondary battery configured as described above, when a film strength of the negative active material layer is in a range of about 50 megapascals to about 250 megapascals, and a content of the negative active material per unit area of the negative active material layer is about 0.01 milligram per square centimeter to about 1.0 milligram per square centimeter, even when the negative active material layer changes volume due to deposition or elution of lithium during charge/discharge processes, damage of the negative active material layer may be suppressed. Therefore, as described above, even when a volume change occurs in the solid secondary battery, charge/discharge processes may be possible without applying an external pressure to the solid secondary battery.

In a specific embodiment of the present disclosure, a content of the particulate carbon per unit area of the negative active material layer may be about 0.01 milligram per square centimeter to about 1 milligram per square centimeter, in order to further enhance discharge rate characteristics of the solid secondary battery.

In a specific embodiment of the present disclosure, a ratio of a peak area of a D-band to a peak area of a G-band in a Raman spectrum of the particulate carbon, may be about 1 to about 3, in order to further enhance discharge rate characteristics of the solid secondary battery.

In a specific embodiment of the present disclosure, an average primary particle diameter of the particulate carbon may be about 5 nanometers to about 55 nanometers.

In a specific embodiment of the present disclosure, the negative active material may include an alloy-forming element including gold, platinum, palladium, silicon, silver, aluminum, bismuth, tin, zinc, or a combination thereof.

In a specific embodiment of the present disclosure, a ratio of a content of the negative active material per unit area of the negative active material layer to a content of the particulate carbon per unit area of the negative active material layer may be about 0.3 to about 5.

In a specific embodiment of the present disclosure, the negative active material may be in a particulate form, and a particle diameter of the negative active material may be about 10 nanometers to about 4 micrometers.

In a specific embodiment of the present disclosure, the negative active material layer further includes a binder, and the binder may be polyvinylidene fluoride, styrene-butadiene rubber (SBR), polytetrafluoroethylene, polyethylene, a vinylidene fluoride-hexafluoropropylene copolymer, polyacrylonitrile, polymethyl methacrylate, or a combination thereof.

In a specific embodiment of the present disclosure, a content of the binder may be about 1 weight percent to about 20 weight percent, with respect to a total weight of the negative active material layer.

In a specific embodiment of the present disclosure, the positive electrode includes a positive active material layer, the negative electrode includes a negative active material layer, and a ratio of a charge capacity of the negative active material layer to a charge capacity of the positive active material layer may satisfy Equation 1:

0.01<b/a<0.5 (1),

wherein
a is a charge capacity of a positive active material layer, and
b is a charge capacity of a negative active material layer.

In a specific embodiment of the present disclosure, a thickness of the negative active material layer may be about 1 micrometer to about 20 micrometers.

In a specific embodiment of the present disclosure, the solid electrolyte may include an oxide solid electrolyte. The oxide solid electrolyte may include Li_{1+x+y}AlₓTi₂₋ₓSi_{y}P_{3-y}O₁₂ wherein 0<x<2 and 0≤y<3, BaTiO₃, Pb(Zr₁₋ₓTiₓO₃ wherein 0≤x≤1, Pb₁₋ₓLaₓZr_{1-y}Ti_{y}O₃ wherein 0≤x<1 and 0≤y<1, Pb(Mg_{1/3}Nb_{2/3})O₃—PbTiO₃, HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ wherein 0<x<2 and 0<y<3, LiₓAl_{y}Ti_{z}(PO₄)₃ wherein 0<x<2, 0<y<1, and 0<z<3, Li_{1+x+y}(Al₁₋ₚGaₚ)ₓ(Ti_{1-q}Ge_{q})₂₋ₓSi_{y}P_{3-y}O₁₂ wherein 0≤x≤1, 0≤y≤1, 0≤p≤1, and 0≤q≤1, LiₓLa_{y}TiO₃ wherein 0<x<2 and 0<y<3, Li₂O, LiOH, Li₂CO₃, LiAlO₂, Li₂O—Al₂O₃—SiO₂—P₂O₅—TiO₂—GeO₂, Li₃₊ₓLa₃M₂O₁₂ wherein M is Te, Nb, Zr, or a combination thererof, and 0≤x≤10, Li₇La₃Zr₂₋ₓTaₓO₁₂ wherein 0<x<2, or a combination thereof. The oxide solid electrolyte may include Li_{1.3}Al_{0.3}Ti_{1.7}(PO₄)₃, Li_{0.34}La_{0.51}TiO_{2.94}, Li_{1.07}Al_{0.69}Ti_{1.46}(PO₄)₃, 50Li₄SiO₄-50Li₂BO₃, 90Li₃BO₃-10Li₂SO₄, Li_{2.9}PO_{3.3}N_{0.46}, Li₇La₃Zr₂O₁₂, or a combination thereof.

In a specific embodiment of the present disclosure, the solid electrolyte layer may further include a binder.

In a specific embodiment of the present disclosure, an arithmetic average height (Sa) of a surface of the solid electrolyte in contact with the negative active material layer may be about 0.05 micrometer to about 0.6 micrometer.

In a specific embodiment of the present disclosure, a lithium deposition layer between the negative electrode current collector and the negative active material layer may be further included, and the lithium deposition layer may include lithium metal, a lithium alloy, or a combination thereof. A thickness of the lithium deposition layer may be about 10 micrometers to about 60 micrometers.

In a specific embodiment of the present disclosure, the positive electrode includes a positive active material layer, the positive active material layer includes a positive active material, and the positive active material may include a lithium cobalt oxide, lithium nickel oxide, lithium nickel cobalt oxide, lithium nickel cobalt aluminum oxide, lithium nickel cobalt manganate, lithium manganate, lithium iron phosphate, nickel sulfide, copper sulfide, lithium sulfide, sulfur, iron oxide, vanadium oxide, or combination thereof. The positive active material may include a lithium transition metal oxide having a layered structure represented by at least one of Formulae 1 to 6:

LiₐNiₓCo_{y}M_{z}O_{2-b}A_{b} Formula 1

wherein in Formula 1,
1.0≤a≤1.2, 0≤b≤0.2, 0.3≤x<1, 0<y≤0.3, 0<z≤0.3, and x+y+z=1,
M is Mn, Nb, V, Mg, Ga, Si, W, Mo, Fe, Cr, Cu, Zn, Ti, Al, or a combination thereof, and
A is F, S, Cl, Br, or a combination thereof,

LiNiₓCo_{y}Mn_{z}O₂. Formula 2

LiNiₓCo_{y}Al_{z}O₂, Formula 3

wherein in Formulae 2 or 3, x, y, and z are each independently 0.3≤x≤0.95, 0<y≤0.2, 0<z≤0.2 and x+y+z=1,

LiNiₓCo_{y}MnᵥAl_{w}O₂. Formula 4

wherein in Formula 4, 0.3≤x≤0.95, 0<y≤0.2, 0<v≤0.2, 0<w≤0.2, and x+y+v+w=1,

LiₐCoₓM_{y}O_{2-b}A_{b}, Formula 5

wherein in Formula 5,
1.0≤a≤1.2, 0≤b≤0.2, 0.9≤x≤1, 0≤y≤0.1, and x+y=1,
M is Mn, Nb, V, Mg, Ga, Si, tungsten (W, Mo, Fe, Cr, Cu, Zn, Ti, Al, or a combination thereof, and
A is F, S, Cl, Br, or a combination thereof, or

LiNiₓMn_{z}O₂. Formula 6

wherein in Formula 6, 0.3≤x<1, 0<z≤0.3 and x+z=1. For example, in formula 1 and 6, 0.5≤x<1, 0.6≤x<1, 0.8≤x<1, 0.85≤x≤0.95, or 0.88≤x≤0.95, respectively. For example, in formulae 2 to 4, 0.5≤x≤0.95, 0.6≤x≤0.95, 0.8≤x≤0.95, 0.85≤x≤0.95, or 0.88≤x≤0.95, respectively.

In a specific embodiment of the present disclosure, the positive electrode may include a positive active material layer, and the positive active material layer may further include a second solid electrolyte, wherein the solid electrolyte and the second solid electrolyte are the same or different. The second solid electrolyte may include an oxide solid electrolyte or a sulfide solid electrolyte.

In a specific embodiment of the present disclosure, the positive electrode may include a positive active material layer, the positive active material layer may further include a liquid electrolyte, and the negative electrode and the solid electrolyte may be free of the liquid electrolyte. The liquid electrolyte may include a lithium salt, an ionic liquid, a polymer ionic liquid, or a combination thereof.

In a specific embodiment of the present disclosure, a compression applied to the solid secondary battery during charge/discharge processes may be about 1 megapascal or less, and a temperature of the solid secondary battery during charge/discharge processes may be about 40° C. or less.

Also disclosed is a method of manufacturing the solid secondary battery, the method including: providing the positive electrode; disposing the solid electrolyte on the positive electrode; and disposing the negative electrode on the solid electrolyte to manufacture the solid secondary battery.

A solid secondary battery module related to the present disclosure may include a solid secondary battery stack including a plurality of the solid secondary battery, and a support member disposed on a side of the solid secondary battery stack, wherein a compression applied by the support member to the solid secondary battery stack may be about 1 megapascal or less.

In a specific embodiment of the present disclosure, as a charging method of the above-described solid secondary battery, the solid secondary battery may be charged beyond a charge capacity of the negative active material layer.

In a specific embodiment of the present disclosure, the solid secondary battery may be charged such that a thickness of a lithium deposition layer deposited in the negative electrode may be about 10 micrometers to 60 micrometers.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a cross-sectional diagram schematically showing an embodiment of a configuration of a solid secondary battery; and

FIG. 2 is a cross-sectional schematic diagram illustrating an embodiment of a form of lithium deposited in a charged solid secondary battery.

### DETAILED DESCRIPTION

Reference will now be made in detail to embodiments, embodiments of which are illustrated in the accompanying drawings, wherein like reference numerals refer to like elements throughout. In this regard, the present embodiments may have different forms and should not be construed as being limited to the descriptions set forth herein. Rather, these embodiments are provided so that this disclosure will be thorough and complete, and will fully convey the scope of the invention to those skilled in the art. Accordingly, the embodiments are merely described below, by referring to the figures, to explain various aspects of the present description. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of at least one of the associated listed items. Expressions such as “at least one of,” when preceding a list of elements, modify the entire list of elements and do not modify the individual elements of the list. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Referring to the accompanying drawings, forms of more preferred examples of the present disclosure will be described in detail.

The present inventive concept described hereinafter may be modified in various ways, and may have many examples, and thus, certain examples are illustrated in the drawings, and are described in detail in the specification. However, this does not intend to limit the present inventive concept within particular embodiments, and it should be understood that the present disclosure includes all the modifications, equivalents, and replacements within the idea and technical scope of the present inventive concept.

Terms used herein are used to describe particular examples, and not to limit the present inventive concept. As used herein, the singular of any term includes the plural, unless the context otherwise requires. The expression of “include” or “have” used herein indicates the existence of a characteristic, a number, a phase, a movement, an element, a component, a material or a combination thereof, and it should not be construed to exclude in advance the existence or possibility of existence of at least one of other characteristics, numbers, movements, elements, components, materials or combinations thereof. As used herein, “/” may be interpreted to mean “and” or “or” depending on the context.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

In the drawings, a thickness is enlarged or reduced to clearly represent various layers and regions. The like reference numerals may refer to like elements throughout the disclosure. As used herein throughout the disclosure, when a layer, a film, a region, or a plate is described to be “on” or “above” something else, it not only includes the case that it is right above something else but also the case when other portions are present in-between. Terms like “first”, “second”, and the like may be used to describe various components, elements, regions, layers and/or sections, but these components, elements, regions, layers and/or sections are not limited by the terms. The terms are used merely for the purpose of distinguishing one component, element, region, layer or section from other component, element, region, layer or section. Thus, “a first element,” “component,” “region,” “layer” or “section” discussed below could be termed a second element, component, region, layer or section without departing from the teachings herein. In the present specification and drawings, the same numerals are given to the components having substantially the same functions and configuration to omit a redundant description.

As used herein, “metal” includes both metal and metalloids such as silicon and germanium and regardless of oxidation state. Thus the metal may be in an elemental form or in an ionic form.

As used herein, “alloy” means a mixture of two or more metals.

As used herein, “charge” and “charging” refer to a process of providing electrochemical energy to a battery.

As used herein, “discharge” and “discharging” refer to a process of removing electrochemical energy from a battery.

As used herein, “positive electrode” and “cathode” refer to an electrode in which electrochemical reduction and lithiation occur during a discharge process.

As used herein, “negative electrode” and “anode” refer to an electrode in which electrochemical oxidation and delithiation occur during a discharge process.

As used herein, “positive active material” refers to a positive electrode material that may undergo lithiation and delithiation.

As used herein, “negative active material” refers to a negative electrode material that may undergo lithiation and delithiation. The “negative active material”, for example, forms an alloy or a compound with lithium by lithiation.

As used herein, “lithiation” and “undergo lithiation” refer to a process of adding lithium to an active material.

As used herein, “delithiation” and “undergo delithiation” refer to a process of removing lithium from an active material.

### 1. Basic Configuration of Solid Secondary Batteries Related to the Present Embodiment

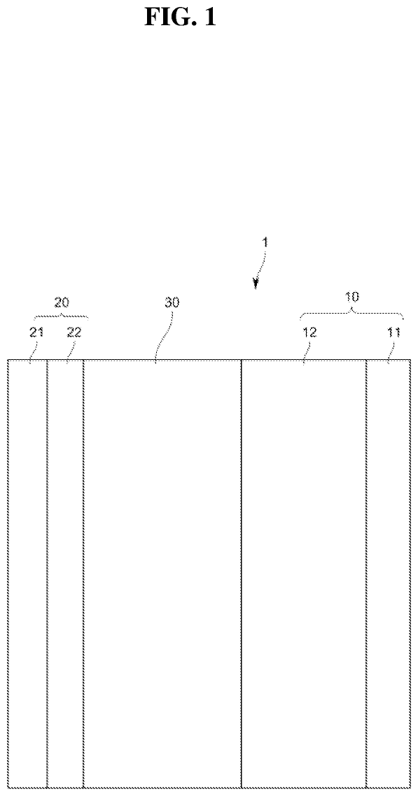

A solid secondary battery is shown in FIG. 1, and comprises a solid secondary battery 1 having a positive electrode 10, a negative electrode 20, and a solid electrolyte 30.

### 1-1. Positive Electrode

A positive electrode 10 includes a positive electrode current collector 11 and a positive active material layer 12. The positive electrode current collector 11 may be a plate or a foil comprising, for example, indium (In), copper (Cu), magnesium (Mg), stainless steel (SUS), titanium (Ti), iron (Fe), cobalt (Co), nickel (Ni), zinc (Zn), aluminum (Al), germanium (Ge), lithium (Li), an alloy thereof, or a combination thereof. A positive electrode current collector 11 may be omitted.

The positive active material layer 12 includes a positive active material and a solid electrolyte. In addition, the solid electrolyte included in the positive electrode 10 may be an oxide solid electrolyte, a sulfide solid electrolyte, or a combination thereof, each of which are further described with respect to the solid electrolyte 30.

The positive active material may reversibly adsorb or release lithium ions.

For example, the positive active material may comprise a lithium transition metal oxide or lithium transition metal phosphate, and may comprise a lithium cobalt oxide (hereinafter referred to as LCO), lithium nickel oxide, lithium nickel cobalt oxide, lithium nickel cobalt aluminum oxide (hereinafter referred to as NCA), lithium nickel cobalt manganate (hereinafter referred to as NCM), lithium manganate, lithium iron phosphate, nickel sulfide, copper sulfide, lithium sulfide, sulfur (S), iron oxide, or vanadium oxide, or a combination thereof.

The positive active material may be a compound represented by at least one of the formulae: LiₐA_{1-b}B′_{b}D₂ (wherein 0.9≤a≤1, and 0≤b≤0.5); LiₐE_{1-b}B′_{b}O_{2-c}D_{c} (wherein 0.9≤a≤1, 0≤b≤0.5, and 0≤c≤0.05); LiE_{2-b}B′_{b}O_{4-c}D_{c} (wherein 0≤b≤0.5, and 0≤c≤0.05); LiₐNi_{1-b-c}—Co_{b}B′_{c}D_{α} (wherein 0.9≤a≤1, 0≤b≤0.5, 0≤c≤0.05, and 0<α≤2); LiₐNi_{1-b-c}Co_{b}B′_{c}O_{2-α}F′_{α} (wherein 0.9≤a≤1, 0.5≤b≤0.5, 0≤c≤0.05, and 0<α<2); LiₐNi_{1-b-c}Co_{b}B′_{c}O₂₋ₐF′₂ (wherein 0.9≤a≤1, 0≤b≤0.5, 0≤c≤0.05, and 0<α<2); LiₐNi_{1-b-c}Mn_{b}B′_{c}D_{α} (wherein 0.9≤a≤1, 0≤b≤0.5, 0≤c≤0.05, and 0<α≤2); LiₐNi_{1-b-c}Mn_{b}B′_{c}O_{2-α}F′_{α} (wherein 0.9≤a≤1, 0≤b≤0.5, 0≤c≤0.05, and 0<α≤2); LiₐNi_{1-b-c}MₙbB′_{c}O₂₋ₐF′₂ (wherein 0.9≤a≤1, 0≤b≤0.5, 0≤c≤0.05, and 0<α<2); LiₐNi_{b}E_{c}G_{d}O₂ (wherein 0.9≤a≤1, 0≤b≤0.9, 0≤c≤0.5, and 0.001≤d≤0.1); LiₐNi_{b}Co_{c}Mn_{d}GₑO₂ (wherein 0.9≤a≤1, 0≤b≤0.9, 0≤c≤0.5, 0≤d≤0.5, and 0.001≤e≤0.1); LiₐNiG_{b}O₂ (wherein 0.9≤a≤1 and 0.001≤b≤0.1); LiₐCoG_{b}O₂ (wherein 0.9≤a≤1 and 0.001≤b≤0.1); LiₐMnG_{b}O₂ (wherein 0.9≤a≤1 and 0.001≤b≤0.1); LiₐMn₂GbO₄ (wherein 0.9≤a≤1 and 0.001≤b≤0.1); QO₂; QS₂; LiQS₂; V₂O₅; LiV₂O₅; LiI′O₂; LiNiVO₄; Li_{(3-f)}J₂(PO₄)₃ (0≤f≤2); Li_{(3-f)}Fe₂(PO₄)₃ (0≤f≤2); LiFePO₄. A combination comprising at least one of the foregoing may be used. In such compounds, A may be Ni, Co, Mn, or a combination thereof; B′ may be Al, Ni, Co, Mn, Cr, Fe, Mg, Sr, V, a rare earth element, or a combination thereof; D may be O, F, S, P, or a combination thereof; E may be Co, Mn, or a combination thereof; F′ may be F, S, P, or a combination thereof; G may be Al, Cr, Mn, Fe, Mg, La, Ce, Sr, V, or a combination thereof; Q may be Ti, Mo, Mn, or a combination thereof; I′ may be Cr, V, Fe, Sc, Y, or a combination thereof; and J may be V, Cr, Mn, Co, Ni, Cu, or a combination thereof. Compounds to which a coating layer is added on the surface may be used, and a mixture of the above-described compound and the compound to which a coating layer is added may also be used. The coating layer added on the surface of these compounds may include, for example, coating element compounds such as an oxide of the coating element, a hydroxide of the coating element, an oxyhydroxide of the coating element, an oxycarbonate of the coating element, a hydroxycarbonate of the coating element, or a combination thereof. The compound that forms such a coating layer may be amorphous or crystalline. The coating element included in the coating layer may be Mg, Al, Co, K, Na, Ca, Si, Ti, V, Sn, Ge, Ga, B, As, Zr, or a mixture thereof. A method of forming a coating layer may not adversely affect the physical properties of the positive active material. A coating method may be, for example, a spray coating method, an immersion method, or a combination thereof. Specific coating methods may be well understood by those skilled in the art, additional details may be determined by one of skill in the art without undue instrumentation, and thus further detailed description is omitted for clarity.

In addition, the positive active material may have a layered rock salt type structure. Here, “layered rock salt type structure” is a structure in which oxygen atom layers and metal atom layers are alternately and regularly arranged in a <111> crystallographic direction of the cubic rock salt type structure, so that each of the atom layers forms a two-dimensional plane. In addition, “cubic rock salt type structure” refers to a sodium chloride type structure, which is a type of crystal structure, and specifically, refers to a structure in which a face centered cubic (fcc) lattice formed by each of the cations and anions is displaced by ½ of the ridge of the unit lattice.

The lithium transition metal oxide having a layered rock salt type structure may be, for example, a lithium transition metal oxide comprising lithium and three additional metals, such as LiNiₓCo_{y}Al_{z}O₂ (NCA) (wherein 0<x<1, 0<y<1, 0<z<1, and x+y+z=1), or LiNiₓCo_{y}Mn_{z}O₂ (NCM) (wherein 0<x<1, 0<y<1, 0<z<1, and x+y+z=1), or a combination thereof. In addition, the lithium transition metal oxide having the layered rock salt type structure may have a high nickel content. For example, the lithium transition metal oxide may be a lithium transition metal oxide having a high content of nickel, such as LiNiaCobAlcO₂ (wherein 0.5<a<1, 0<b<0.3, 0<c<0.3, and a+b+c=1) or LiNiₐCo_{b}Mn_{c}O₂ (wherein 0.5<a<1, 0<b<0.3, 0<c<0.3, and a+b+c=1). When the positive active material includes the lithium transition metal oxide having the above-described layered salt rock type structure, energy density and thermal stability of the solid secondary battery 1 may be enhanced.

In addition, a compound in which a coating layer is on the surface of the positive active material may be used, or a mixture of the above-described compound and the compound with a coating layer may also be used. The coating layer may include a coating element compound, such as an oxide of the coating element, a hydroxide of the coating element, an oxyhydroxide of the coating element, an oxycarbonate of the coating element, a hydroxycarbonate of the coating element, or a combination thereof. The compound that forms such a coating layer may be amorphous or crystalline. As a coating element included in the coating layer, Mg, Al, Co, K, Na, Ca, Si, Ti, V, Sn, Ge, Ga, B, As, Zr, or a combination thereof may be used. A process of forming a coating layer may use any suitable coating method which may coat the compound using these elements and does not adversely affect the physical properties of the positive active material. Representative coating methods include for example, a spray coating method, or an immersion method, additional details of which can be determined by one of skill in the art without undue instrumentation, and thus further detailed description thereof will be omitted.

The positive active material may be, for example, coated by a coating layer. The coating layer may be a coating layer of a positive active material of an all-solid secondary battery 1, and may be known in the art. The coating layer may be, for example, Li₂O—ZrO₂, or the like.

In addition, as the positive active material is a lithium transition metal oxide, such as NCA or NCM, when the positive active material includes nickel (Ni), a capacity density of the solid secondary battery 1 is increased, and thus, metal elution from the positive active material in a charging state may be decreased. Accordingly, the solid secondary battery 1 may have improved long-term reliability in a charged state and improved cycle characteristics.

The positive active material may have any suitable shape and may be, for example, a particle shape such as a sphere, a cylinder, a flake, or an elliptical sphere. In addition, a particle diameter of the positive active material is not particularly limited, and may be within a range that may be applied to a positive active material of a solid secondary battery in the art. In addition, a content of the positive active material in the positive electrode layer 10 is not particularly limited, and may be within a range that may be applied to a positive electrode of a solid secondary battery in the art.

The positive active material layer 12 may include a sulfide solid electrolyte and the sulfide solid electrolyte may be, for example, Li₂S—P₂S₅, Li₂S—P₂S₅—LiX (X is, for example, a halogen atom such as I or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅-ZmSn (wherein m and n are positive numbers, and Z is Ge, Zn, Ga, or a combination thereof), Li₂S—GeS₂, Li₂S—SiS₂—Li₃PO₄, Li₂S—SiS₂-LiₚMO_{q} (wherein p and q are each independently 1 to 20, M is P, Si, Ge, B, Al, Ga, In, or a combination thereof), or a combination thereof. The sulfide solid electrolyte may include sulfur (S), phosphorus (P) and lithium (Li). Specifically, the sulfide solid electrolyte may include Li₂S—P₂S₅. When the sulfide solid electrolyte including Li₂S—P₂S₅ is used, a mole ratio for mixing Li₂S and P₂S₅ may be, for example, selected within a molar range of Li₂S:P₂S₅ of 50:50 to 90:10. The sulfide solid electrolyte may be amorphous or crystalline. In addition, the sulfide solid electrolyte may comprise a mixture of amorphous sulfide solid electrolyte and crystalline sulfide solid electrolyte. The sulfide solid electrolyte may include, for example, Li₇P₃S₁₁, Li₇PS₆, Li₄P₂S₆, Li₃PS₆, Li₃PS₄, Li₂P₂S₆, or a combination thereof.

The sulfide solid electrolyte may include, for example, an argyrodite type solid electrolyte represented by Formula 7:

Li⁺₁₂₋ₙ₋ₓAⁿ⁺X²⁻₆₋₋ₓY′⁻ₓ, Formula 7

wherein in Formula 7, A is P, As, Ge, Ga, Sb, Si, Sn, Al, In, Ti, V, Nb, Ta, or a combination thereof, X is S, Se, Te, or a combination thereof, Y is Cl, Br, I, F, CN, OCN, SCN, N₃, or a combination thereof, 0<n<12, and 0≤x≤2.

The argyrodite type solid electrolyte may be, for example, Li₇₋ₓPS₆₋ₓClₓ (wherein 0≤x≤2), Li₇₋ₓPS₆₋ₓBrₓ (wherein 0≤x≤2), and Li₇₋ₓPS₆₋ₓIₓ (wherein 0≤x≤2), or a combination thereof. The argyrodite type solid electrolyte may be, more specifically, Li₆PS₅Cl, Li₆PS₅Br, Li₆PS₅I, or a combination thereof.

In addition, in the positive active material layer 12, for example, an additive, such as a conductor, a binder, a filler, a dispersant, an ion conductor, or a combination thereof, may be included in addition to the above-described positive active material and solid electrolyte.

The conductor that may be included in the positive active material layer 12 maybe, for example, graphite, carbon black, acetylene black, KETJEN BLACK, carbon fiber, or a metal powder. In addition, the binder that may be included in the positive active material layer 12 may be, for example, styrene butadiene rubber (SBR), polytetrafluoroethylene, polyvinylidene fluoride, polyethylene, or a combination thereof. In addition, for the filler, the dispersant, or the ion conductor may be included in the positive active material layer 12, and any suitable material known in the art used in an electrode of an all-solid secondary battery may be used.

The positive electrode layer 10 may further include a liquid electrolyte, in addition to the above-described components. Specifically, the positive active material layer 12 may be impregnated with the liquid electrolyte.

The liquid electrolyte may include a lithium salt, an ionic liquid, a polymeric ionic liquid, or a combination thereof. The liquid electrolyte may be nonvolatile.

The ionic liquid may have a melting point below room temperature, e.g., below 22° C., and may consists of ions only, and may be a salt in a liquid state or a molten salt at room temperature.

The ionic liquid may be a compound comprising a cation comprising ammonium, pyrrolidinium, pyridinium, pyrimidinium, imidazolium, piperdinium, pyrazolium, oxazolium, pyridium, phosphonium, sulfonium, triazolium, or a combination thereof, and comprising an anion comprising BF₄⁻, PF₆⁻, AsFe₆⁻, SbF₆⁻, AlCl₄⁻, HSO₄⁻, ClO₄⁻, CH₃SO₃⁻, CF₃CO₂⁻, Cl⁻, Br⁻, I⁻, BF₄⁻, SO₄⁻, CF₃SO₃⁻, (FSO₂)₂N⁻, (C₂F₅SO₂)₂N⁻, (C₂F₅SO₂)(CF₃SO₂)N⁻, (CF₃SO₂)₂N⁻, or a combination thereof.

Specific examples of the ionic liquid may be, for example, N-methyl-N-propylpyrrolidinium bis(trifluoromethanesulfonyl)imide, N-propyl-N-methylpyrrolidinium bis(3-trifluoromethylsulfonyl)imide, N-Butyl-N-methylpyrrolidium bis(3-trifluoromethylsulfonyl)imide, 1-butyl-3-methylimidazolium bis(trifluoromethylsulfonyl)amide, 1-ethyl-3-methylimidazolium bis(trifluoromethylsulfonyl)amide, or a combination thereof.

The polymeric ionic liquid may contain a repeating unit including a cation comprising ammonium, pyrrolidinium, pyridinium, pyrimidinium, imidazolium, piperidinium, pyrazolium, oxazolium, pyridium, phosphonium, sulfonium, triazolium, or a combination thereof, and including an anion comprising BF₄, PF₆⁻, AsF₆⁻, SbF₆⁻, AlCl₄⁻, HSO₄⁻, ClO₄⁻, CH₃SO₃⁻, CF₃CO₂⁻, (CF₃SO₂)₂N⁻, (FSO₂)₂N⁻, Cl⁻, Br⁻, I⁻, SO₄⁻, CF₃SO₃⁻, (C₂FsSO₂)₂N⁻, (C₂F₅SO₂)(CF₃SO₂)N⁻, NO₃⁻, Al₂Ci₇⁻, (CF₃SO₂)₃C⁻, (CF₃)₂PF₄⁻, (CF₃)₃PF₃⁻, (CF₃)₄PF₂⁻, (CF₃)₅PF⁻, (CF₃)₆P⁻, SF₅CF₂SO₃, SF₅CHFCF₂SO₃, CF₃CF₂(CF₃)₂CO⁻, (CF₃SO₂)₂CH⁻, (SF₅)₃C⁻, (O(CF₃)₂C₂(CF₃)₂O)₂PO⁻, or a combination thereof.

For the lithium salt, any suitable lithium salt in the art may be used. For example, the lithium salt may be LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (wherein x and y are natural numbers), LiCl, LiI, or a combination thereof.

A concentration of the lithium salt, ionic liquid, or polymer ionic liquid included in the liquid electrolyte may each independently be about 0.1 molar (M) to about 5 M.

An amount of the liquid electrolyte disposed in the positive active material layer 12 may be, with respect to 100 parts by weight of a positive active material layer 12 not including the liquid electrolyte, about 0 to about 100 parts by weight, about 0 to about 50 parts by weight, about 0.1 to about 30 parts by weight, about 1 to about 20 parts by weight, about 2 to about 10 parts by weight, or about 3 to about 5 parts by weight, wherein the endpoints of the foregoing ranges are independently combinable.

When the positive active material layer 12 further includes the liquid electrolyte, the negative electrode 20 and the solid electrolyte 30 may not include, for example, the liquid electrolyte. That is, the liquid electrolyte is disposed only in the positive electrode 10, and the liquid electrolyte may be intentionally not added to, omitted from, or not present in the negative electrode 20 and the solid electrolyte 30.

### 1-2. Negative Electrode

A negative electrode 20 includes a negative electrode current collector 21 and a negative active material layer 22 disposed on the negative electrode current collector 21. The negative electrode current collector 21 may comprise a material that does not react with lithium, that is, that does not form an alloy or a compound with lithium, e.g., when contacted with lithium metal. The negative electrode current collector 21 may comprise, for example, copper (Cu), stainless steel (SUS), titanium (Ti), iron (Fe), cobalt (Co), nickel (Ni), or a combination thereof. The negative electrode current collector 21 may comprise an alloy of one or more of the foregoing metals or clad materials. The negative electrode current collector 21 may be, for example, in a form of a plate or in a form of a foil. Use of copper foil or aluminum foil is mentioned.

The negative active material layer 22 may comprise, a negative active material, a carbon-based (i.e., carbonaceous) material, and a binder.

The negative active material may comprise, for example, an alloy-forming element that forms an alloy or a compound with lithium by an electrochemical reaction during charge. The alloy-forming element may be gold, platinum, palladium, silicon, silver, aluminum, bismuth, tin, zinc, or a combination thereof. When gold, platinum, palladium, silicon, silver, aluminum, bismuth, tin, zinc, or a combination thereof, are used as the alloy-forming element, the negative active material may be, for example, in a particulate form, and a particle diameter of the negative active material may be about 4 micrometers (μm) or less, about 1 μm or less, about 500 nanometers (nm) or less, about 300 nm or less, or about 100 nm or less. A particle diameter of the negative active material may be, for example, about 10 nm to about 4 μm, about 20 nm to about 1 μm, about 30 nm to about 500 nm, about 40 nm to about 300 nm, or about 50 nm to about 100 nm, wherein the endpoints of the foregoing range are each independently combinable. When the particle diameter of the negative active material is within the foregoing range, characteristics of the solid secondary battery 1 may be further improved. For the particle diameter of the negative active material, a median diameter (that is, a D50 particle diameter) may be measured using, for example, a laser particle size analyzer.

The carbon-based material may be, for example, carbon black, or graphene. the carbon black may be, for example, acetylene black, furnace black, or KETJEN BLACK.

A nitrogen adsorption specific surface area of the carbon-based material may be, for example, about 1 square meter per gram (m²/g) to about 500 m²/g, about 10 m²/g to about 450 m²/g, about 25 m²/g to about 400 m²/g, or about 50 m²/g to about 300 m²/g, wherein the endpoints of the foregoing range are each independently combinable.

Here, the “nitrogen adsorption specific surface area” of the carbon-based material is, when the carbon-based material contained in the negative active material layer 22 is one kind of carbon-based material, the nitrogen adsorption specific surface area of the corresponding one kind of carbon-based material. In addition, when there is a plurality of kinds of carbon-based material contained in the negative active material layer 22, the “nitrogen adsorption specific surface area” of the carbon-based material may be a weighted average of the nitrogen adsorption specific surface area of the plurality of kinds of carbon-based material.

The nitrogen adsorption specific surface area of the carbon-based material may be measured using a nitrogen adsorption method (JIS K6217-2:2001). Specifically, the carbon-based material such as carbon black is deaerated once at a high temperature of about 300° C. and is cooled to a temperature of liquid nitrogen under a nitrogen atmosphere. Then, a mass increase (amount of nitrogen adsorption) of the carbon-based material and the pressure of the nitrogen atmosphere are measured after the carbon-based material reaches an equilibrium state, and the values are applied to a Brunauer-Emmett-Teller (BET) equation to calculate a value of a nitrogen adsorption specific surface area.

Additives used in a solid secondary battery in the art, for example, a binder, a filler, a dispersant, an ion conductor, or a solid electrolyte, may be appropriately included in the negative active material layer 22, in addition to the above-described materials. The conductor that may be mixed to the negative active material layer 22 is, for example, graphite, carbon black, acetylene black, ketjen black, carbon fiber, or metal powder. In addition, the binder that may be included in the negative active material layer 22 may be, for example, styrene butadiene rubber (SBR), polytetrafluoroethylene, polyvinylidene fluoride, polyethylene, vinylidene fluoride-hexafluoropropylene copolymer, polyacrylonitrile, polymethyl methacrylate or a combination thereof. In addition, for the filler, the dispersant, and the ion conductor, that may be included in the negative active material layer 22, any suitable material known in the art used in an electrode of an all-solid secondary battery may be used.

### 1-3. Solid Electrolyte

A solid electrolyte 30 is arranged between the positive electrode 10 and the negative electrode 20.

For the solid electrolyte, in the present embodiment, an oxide solid electrolyte may be used.

The oxide solid electrolyte may be crystalline, amorphous, or a combination thereof.

The oxide solid electrolyte may include, for example, Li_{1+x+y}AlₓTi₂₋ₓSi_{y}P_{3-y}O₁₂ (0<x<2 and 0≤y<3), BaTiO₃, Pb(Zr₁₋ₓTiₓ)O₃ (PZT, 0≤x≤1), Pb₁₋ₓLaₓZr_{1-y}Ti_{y}O₃ (PLZT, 0≤x<1 and 0≤y<1), Pb(Mg_{1/3}Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ (0<x<2 and 0<y<3), LiₓAl_{y}Ti_{z}(PO₄)₃ (0<x<2, 0<y<1 and 0<z<3), Li_{1+x+y}(Al₁₋ₚGaₚ)ₓ(Ti_{1-q}Ge_{q})₂₋ₓSi_{y}P_{3-y}O₁₂ (0≤x≤1, 0≤y≤1, 0≤p≤1, and 0≤q≤1), LiₓLa_{y}TiO₃ (0<x<2 and 0<y<3), Li₂O, LiOH, Li₂CO₃, LiAlO₂, Li₂O—Al₂O₃—SiO₂—P₂O₅—TiO₂—GeO₂, Li₃₊ₓLa₃M₂O₁₂ (M=Te, Nb, Zr, 0≤x≤10), Li₇La₃Zr₂₋ₓTaₓO₁₂ (LLZ-Ta, 0<x<2,), or a combination thereof.

The oxide solid electrolyte may be, for example, Li_{1.3}Al_{0.3}Ti_{1.7}(PO₄)₃, Li_{0.34}La_{0.51}TiO_{2.94}, Li_{1.07}Al_{0.69}Ti_{1.46}(PO₄)₃, 50Li₄SiO₄-50Li₂BO₃, 90Li₃BO₃-10Li₂SO₄, Li_{2.9}PO_{3.3}N_{0.46}, Li₇La₃Zr₂O₁₂, or a combination thereof.

The solid electrolyte 30 may further include a binder. The binder included in the solid electrolyte 30 may be, for example, styrene butadiene rubber (SBR), polytetrafluoroethylene, polyvinylidene fluoride, or polyethylene. The binder in the solid electrolyte 30 may be the same as or different from the binder in the positive active material layer 12 and the negative active material layer 22.

In an embodiment, the solid electrolyte 30 may comprise the above-described oxide solid electrolyte as the solid electrolyte. Mentioned is an embodiment in which the solid electrolyte 30 consists of the oxide solid electrolyte.

In the present embodiment, for example, a surface roughness of the solid electrolyte 30 may be, for example, in the range of about 0.05 micrometers (μm) to about 0.6 μm, about 0.1 μm to about 0.5 μm s, or about 0.2 μm to about 0.4 μm, wherein the surface roughness of the solid electrolyte is determined as an arithmetic average height (Sa). By selecting the surface roughness of the contact surface of the solid electrolyte 30 and the negative active material layer 22, a contact area of the solid electrolyte 30 and the negative active material layer 22 may be increased, thereby improving a binding strength of the solid electrolyte 30 and the negative active material layer 22. The binding strength between the negative active material layer 22 and the solid electrolyte 30 may be, for example, 14 millinewtons per millimeter (mN/mm) to 98 mN/mm, or 20 mN/mm to 61 mN/mm.

In addition, the binding strength between the negative active material layer 22 and the solid electrolyte 30 may be measured by measuring a peel strength using an AGS-X instrument, manufactured by Shimadzu Co., Ltd.

### 1-4. Relationship Between Charge Capacities of the Positive Electrode and the Negative Electrode

The solid secondary battery 1 related to the present embodiment is configured so that a ratio of a charge capacity of the negative active material layer 22 to a charge capacity of the positive active material layer 12, that is, a capacity ratio, satisfies Equation 1:

0.01<b/a<0.5, Equation 1

wherein
a is a charge capacity (mAh) of a positive active material layer 12, and
b is a charge capacity (mAh) of a negative active material layer 22.

The capacity ratio may be, for example, 0.01<b/a≤0.45, 0.01<b/a≤0.4, 0.02≤b/a≤0.3, 0.03≤b/a≤0.25, 0.03≤b/a≤0.2, or 0.05≤b/a≤0.1.

Here, the charge capacity of the positive active material layer 12 may be obtained by multiplying the mass of the positive active material in the positive active material layer 12 and the specific charge capacity (milliampere hours per gram, mAh/g) of the positive active material. When multiple kinds of positive active materials are used, a weighted average may be used, e.g., a value of a specific charge capacity x mass for each positive active material may be calculated and the sum of these values may be referred to as the charge capacity of the positive active material layer 12. The charge capacity of the negative active material layer 22 may be calculated in the same way. That is, the charge capacity of the negative active material layer 22 may be obtained by multiplying the mass of the negative active material in the negative active material layer 22 to the specific charge capacity (mAh/g) of the negative active material. When multiple kinds of negative active materials are used, a weighted average may be used, e.g., a value of a specific charge capacity×mass for each negative active material may be calculated and the sum of these values may be referred to as the charge capacity of the negative active material layer 22. Here, charge capacities of the positive active material and the negative active material are specific capacities determined using all-solid half-cells that use lithium metal as a counter electrode. Charge capacities of the positive active material and the negative active material may be directly measured using all-solid half-cells.

As a specific method of directly measuring a charge capacity, the following method may be used. Firstly, the charge capacity of a positive active material layer 12 may be measured by preparing an all-solid half-cell using the positive active material layer 12 as a working electrode and Li as a counter electrode, and performing a constant current-constant voltage (CC-CV) charge from an open circuit voltage (OCV) to a maximum charging voltage. The maximum charging voltage is set by the specification of JIS C 8712: 2015, and is 4.25 V for a lithium cobalt oxide-based positive electrode, and for other positive electrodes, the maximum charging voltage refers to a voltage that may be obtained by applying the regulations of A.3.2.3 of JIS C 8712: 2015 (safety requirements when applying other maximum charging voltages). The charge capacity of the negative active material layer 22 may be measured by preparing an all-solid half-cell using the negative active material layer 22 as a working electrode and Li as a counter electrode, and performing a CC-CV charge from an open circuit voltage (OCV) to 0.01 V.

The above-described test cells may be, for example, prepared in the following method. The positive active material layer 12 or the negative active material layer 22 of which charge capacity is to be measured is provided in a disk form of 13 millimeters (mm) in diameter. Solid electrolyte powder 200 milligrams (mg), the same as used in the solid secondary battery 1, is hardened at 40 megapascals (MPa) to form a pellet of 13 mm in diameter and 1 mm in thickness. The pellet is put into a tube of 13 mm in internal diameter, and the positive active material layer 12 or the negative active material layer 22 provided in a disk form is put into the tube from one side, and a lithium foil of 13 mm in diameter and 0.03 mm in thickness is put into the tube from the other side. In addition, stainless steel disks are put into the tube one from each side, and the whole assembly is pressurized for 1 minute at 300 MPa in the axial direction of the tube to integrate the contents. The integrated content is taken out of the tube and is sealed in a case in which 22 MPa of pressure is always applied. The charge capacity of a positive active material layer 12 may be measured by, for example, charging the test cell prepared as described above at a constant current (CC) of 0.1 milliampere (mA), and charging at a constant voltage (CV) until the current reaches 0.02 mA.

Specific charge capacities are calculated by dividing the charge capacities measured in this way by each of the masses of the active materials. Initial charge capacities of the positive active material layer 12 and the negative active material layer 22 may be initial charge capacities measured during charge at the first cycle. This value is used in examples described later.

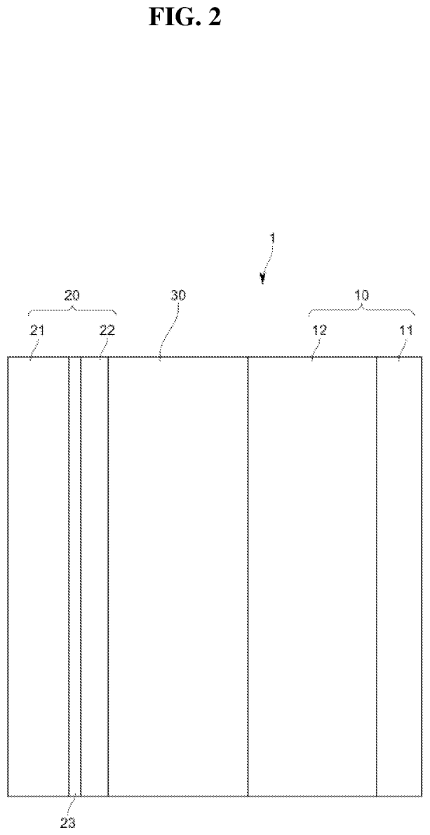

In this way, the charge capacity of the positive active material layer 12 is set to be excessively large in comparison to the charge capacity of the negative active material layer 22. In the present embodiment, an all-solid secondary battery is charged beyond the charge capacity of the negative active material layer 22. In other words, the negative active material layer 22 is overcharged. In early stages of charging, lithium is adsorbed in the negative active material layer 22. That is, the negative active material forms an alloy with lithium ions that moved from the positive electrode layer 10. When the negative active material layer 22 is further charged beyond its capacity, as shown in FIG. 2, lithium is deposited on the back side of the negative active material layer 22, that is, between the negative electrode current collector 21 and the negative active material layer 22, and the lithium forms a lithium deposition layer 23. The lithium deposition layer 23 comprises lithium, although other elements may be contained in small amounts.

Such a phenomenon is caused by a specific substance contained in the negative active material layer 22, that is, an alloy-forming element that forms an alloy or a compound with lithium. During discharge, lithium inside the negative active material layer 22 and the lithium deposition layer 23 ionizes and moves to the side of the positive electrode 10.

Thus, in the solid secondary battery 1 related to the present embodiment, the deposited lithium may be used as a negative active material. In addition, since the negative active material layer 22 covers the lithium deposition layer 23, the negative active material 22 acts as a protective layer for the lithium deposition layer, and at the same time, may suppress deposition and growth of lithium dendrites. By this, a short circuit occurrence and a capacity deterioration of the solid secondary battery are suppressed, and furthermore, characteristics of the solid secondary battery are improved. The capacity ratio is more than about 0.01. When the capacity ratio is about 0.01 or less, characteristics of the solid secondary battery are deteriorated. The reason may be that the negative active material layer 22 may not function sufficiently as a protective layer. For example, when a thickness of the negative active material layer 22 is very thin, the capacity ratio may be less than about 0.01. In this case, the negative active material layer 22 may collapse due to repetition of charge/discharge processes, and lithium dendrites may deposit and grow. As a result, characteristics of the solid secondary battery may be deteriorated. Japanese Patent Publication No. 2021-0518656, the content of which is incorporated herein by reference in its entirety, indicates that characteristics of a solid secondary battery are not sufficiently improved because an interface layer or a carbon layer is too thin. In addition, the capacity ratio may be smaller than about 0.5. When the capacity ratio is about 0.5 or more, an amount of lithium deposit at the negative electrode is reduced, and battery capacity may decrease. For the same reason, the capacity ratio may be less than about 0.25. In addition, output characteristics of the battery may be further improved by the capacity ratio less than about 0.25.

A thickness of the negative active material layer 22 is not particularly limited within the range that satisfies Equation 1, and for example, may be about 1 μm to about 20 μm, about 1 μm to about 15 μm, or about 1 μm to about 10 μm.

When the thickness of the negative active material layer 22 is less than about 1 μm, characteristics of the solid secondary battery 1 may not be sufficiently improved. When the thickness of the negative active material layer 22 exceeds about 20 μm, resistance value of the negative active material layer 22 is increased, and as a result, characteristics of the solid secondary battery are not sufficiently improved.

The thickness of the above-described negative active material layer 22 may be estimated by observing an average thickness of the cross section using a scanning electron microscope (SEM) after assembling the all-solid solid secondary battery and performing molding using pressure.

### 2. Configuration of the Solid Secondary Battery

The solid secondary battery is configured so that a film strength of the negative active material layer 22 is in a range of about 50 MPa to about 250 MPa. The film strength of the negative active material layer 22 in this range may be, for example, about 60 MPa to about 240 MPa, about 70 MPa to about 200 MPa, about 80 MPa to about 180 MPa, or about 90 MPa to about 150 MPa, wherein the endpoints of the foregoing ranges may each be independently combinable.

The film strength of the negative active material layer 22 may be measured by measuring a shear strength using a surface and interfacial characterization analysis system (SAICAS) manufactured by Daipla Wintes Co., Ltd.

As a method of adjusting the film strength of the negative active material layer 22 in the above-described range, a content of the negative active material, a content of the carbon-based material, or a content of the binder may be selected.

In particular, selecting the content of the binder has a conspicuous effect. When the content of the binder is increased, the film strength of the negative active material layer 22 is enhanced. On the other hand, in order to maintain high energy density of the negative active material layer 22, the content of the binder may be decreased. The content of the binder for balancing the film strength and the energy density of the negative active material layer may be, with respect to the total weight of the negative active material layer, about 1 weight percent (wt %) to about 20 wt %, about 3 wt % to about 18 wt %, or about 7 wt % to about 15 wt %, wherein the endpoints of the foregoing ranges are independently combinable.

In the present embodiment, the binder used in the negative active material layer 22 may be, for example, styrene butadiene rubber (SBR), polytetrafluoroethylene, polyvinylidene fluoride, polyethylene, poly(methyl methacrylate) (PMMA), or a combination thereof.

The carbon-based material may be in a particulate form.

An average primary particle diameter of the particulate carbon may be about 5 nm to about 55 nm, about 10 nm to about 50 nm, or about 12 nm to about 40 nm.

An average primary particle diameter of the particulate carbon may be obtained by performing a carbon black (CB) morphological analysis using a scanning electron microscope (JSM-6700 F) according to ASTM D3849-13, and calculating an average primary particle diameter m corresponding to m in the method disclosed in ASTM D3849-13, the content of which is incorporated herein by reference in its entirety.

A ratio (D/G) of peak areas of a D-band (D value) and a G-band (G value) of a Raman spectrum of the particulate carbon may be, for example, about 1 to about 3, about 1 to about 2.8, or about 1.5 to about 2.5, wherein the endpoints of the foregoing ranges are independently combinable.

In addition, the peak area ratio (D/G) may be obtained using a microscopic Raman spectrophotometer (Japan Spectroscopic Co., Ltd., NRS-4100) and measuring the Raman spectrum of the particulate carbon. Specifically, at a laser wavelength of 532 nm, a measurement of the particulate carbon is performed between 600 wavenumbers (cm⁻¹) to 1200 cm⁻¹. From these measurement results, a peak area of a spectrum (D-band) in the frequency band of 1200 cm⁻¹ to 1400 cm⁻¹ is set to be a D value, and a peak area of a spectrum (G band) in the frequency band of 1550 cm⁻¹ to 1700 cm⁻¹ is set to be a G value, and a ratio of the D value and the G value may be calculated as the peak area ratio (D/G).

A content of a negative active material in the negative active material layer 22 may be, for example, about 0.01 milligram per square centimeter (mg/cm²) to about 1 mg/cm², about 0.05 mg/cm² to about 0.8 mg/cm², about 0.08 mg/cm² to about 0.77 mg/cm², or about 0.1 mg/cm² to about 0.4 mg/cm², wherein the endpoints of the foregoing ranges are independently combinable.

A content of the particulate carbon in the negative active material layer 22 may be, for example, about 0.01 mg/cm² to about 1 mg/cm², about 0.05 mg/cm² to about 0.8 mg/cm², about 0.1 mg/cm² to about 0.8 mg/cm², or about 0.1 mg/cm² to about 0.7 mg/cm², wherein the endpoints of the foregoing ranges are independently combinable.

A ratio (A1/A2) of a content of the negative active material per unit area of the negative active material layer (A1) and a content of the particulate carbon per unit area of the negative active material layer (A2) may be about 0.3 to about 5, about 0.35 to about 5.0, about 0.4 to about 5, about 0.5 to about 5.0, about 0.6 to about 3, or about 0.6 to about 2, wherein the endpoints of the foregoing ranges are independently combinable.

### 3. Preparation Method of the Solid Secondary Battery

A manufacturing method of the solid secondary battery according to an embodiment will be described. The solid secondary battery may be prepared by preparing each of the positive electrode 10, the negative electrode 20, and the solid electrolyte 30, and stacking each of the forgoing.

### 3-1. Process of Preparing the Positive Electrode

First, materials of the positive active material layer 12 (the positive active material, the binder, etc.) are mixed, and stacked on the positive electrode current collector 11, and the stack is compressed (for example, compressed using a hydrostatic press) to prepare the positive electrode 10. A compression process may be omitted. The mixture of the materials of the positive active material layer 12 may be molded by compression in a form of a pellet, or be stretched in a sheet form, to prepare the positive electrode 10. In case of preparing the positive electrode 10 using such a method, the positive electrode current collector 11 may be compressed to the prepared pellet or sheet. The positive active material layer 12 may be formed by applying a slurry (the slurry may be a paste), which is prepared by adding materials of the positive active material layer to a non-polar solvent, on the positive electrode current collector 11 and by drying the slurry. In the present embodiment, an ionic liquid electrolyte is impregnated to the positive active material layer 12 formed this way.

### 3-1. Process of Preparing the Negative Electrode

First, a second slurry is prepared by adding materials of the negative active material layer 22 (a negative active material, an element not forming an alloy, a binder, etc.) to a polar solvent or a non-polar solvent. Subsequently, the obtained slurry is applied on the negative electrode current collector 21 and is dried. Subsequently, the obtained stack is compressed (for example, compressed using a hydrostatic press) to prepare the negative electrode 20. A compression process may be omitted. In addition, the negative electrode 20 may be formed by preparing the negative active material layer 22 separately, and then stacking the negative active material layer on the negative electrode current collector 12 and pressurizing the stack.

### 3-3. Process of Preparing the Solid Electrolyte

The solid electrolyte 30, for example, may be prepared by the following order or process.

The solid electrolyte 30 is prepared by a mixing process of mixing starting materials to obtain a mixture of materials, and a calcining process of heat-treating the mixture of materials at a high temperature. Here, as an example, a method of preparing the solid electrolyte 30 comprising a sintered body of a garnet-type oxide is described.

In the mixing process, a mixture is obtained by mixing materials comprising, for example, at least a component of Li, a component of La, a component of Zr, or a combination thereof, as starting materials.

Each component is comprised in the mixture in a proportion that allows a lithium-ion conductive ceramic material having a garnet-type crystal structure or a crystal structure similar to or isostructural with a garnet-type crystal structure to be obtained. As used herein, the term “garnet compound” or “garnet-type compound or crystal structure” means that the compound is isostructural with garnet, e.g., Mg₃Al₂(SiO₄)₃. A garnet-type compound or crystal structure is a compound or crystal structure of the formula X₃Y₂(SiO₄)₃, wherein X is a divalent cation, such as Ca²⁺, Mg²⁺, Fe²⁺, Mn²⁺, or a combination thereof, and Y is a trivalent cation, such as Al³⁺, Fe³⁺, Cr³⁺, or a combination thereof.

For example, a sintering agent such as a boron oxide is added to the mixture, and a precursor powder is obtained by mixing the mixture in a ball mill or a jet mill.

The precursor powder obtained in this way is put into a mold, or the like, and a compression molding is performed to obtain a precursor pellet.

Subsequently, in a sintering process, the precursor pellet molded as described above is heated for about 1 hour to about 36 hours at a temperature of about 900° C. to about 1250° C. During this process, the sintering temperature and the sintering time may be changed appropriately depending on the combination of materials.

Heating methods are not particularly limited, and resistance heating or microwave heating may be used. The sintering process may be performed in 2 steps of pseudo-sintering, and main-sintering, and the above-described molding process may be included in the sintering process, and a plasma sintering method or a spark plasma sintering method may be applied.

In addition, a surface roughness of the solid electrolyte 30 after sintering may be adjusted through grinding or an acid treatment. The surface roughness may be selected by selecting grinding conditions or an intensity of the acid treatment. The intensity of the acid treatment may be controlled by for example, adjusting concentration of the acid being used, treatment time, treatment temperature, etc.

### 3-4. Assembly Process of Solid Secondary Battery

A solid secondary battery 1 related to the present embodiment may be prepared by stacking the positive electrode 10, negative electrode 20, and solid electrolyte 30 prepared in the above-described manner, so that the positive electrode and the negative electrode 20 are arranged on each side of the solid electrolyte 30, and by compressing (for example, compressing using a hydrostatic press) the same.

### 4. Charging Method of Solid Secondary Batteries

Subsequently, a charging method of the solid secondary battery 1 is described. In the present embodiment, as described above, the all-solid secondary battery 1 is charged beyond the charge capacity of the negative active material layer 22. In other words, the negative active material layer 22 is overcharged. In early stages of charging, lithium is adsorbed in the negative active material layer 22. When charging beyond the charge capacity of the negative active material layer 22, lithium is deposited on the back side of the negative active material layer 22, that is, between the negative electrode current collector 21 and the negative active material layer 22. The lithium forms a lithium deposition layer 23 that did not exist at the time the solid secondary battery 1 was manufactured. During discharge, lithium inside the negative active material layer 22 and the lithium deposition layer 23 ionizes and moves to the side of the positive electrode 10.

In addition, the charging amount may be in a range of about 2 times to about 100 times, or about 4 times to about 100 times the charging capacity of the negative active material layer 22, wherein the endpoints of the foregoing ranges are independently combinable.

When charging this way, a thickness of the lithium deposition layer 23 inside the negative electrode 20 may be about 10 micrometers (μm) or greater, or about 20 μm or greater. The thickness of the lithium deposition layer 23 may be in a range of less than 60 μm, which is an upper limit that may be implemented in a solid secondary battery. The thickness of the lithium deposition layer 23 may be, for example, about 10 μm to about 60 μm, about 15 μm to about 60 μm, or about 20 μm to about 60 μm. In addition, the thickness of the lithium deposition layer 23 may be estimated by observing an average thickness of the cross section using a scanning electron microscope (SEM) after charging the solid secondary battery 1.

### 5. Effects of the Present Embodiment

According to the solid secondary battery 1 formed as described above, a film strength of the negative active material layer 22 may be about 50 MPa to about 250 MPa, and even when charging/discharging without compressing with a compression jig, damage of the negative active material layer 22 may be suppressed. As a result, by repeating charge/discharge processes of the solid secondary battery 1 without applying an external pressure to the solid secondary battery 1, it is possible to realize a solid secondary battery 1 providing a high discharge rate and high cycle characteristics.

In addition, in the present embodiment, since the positive electrode 10 contains a liquid electrolyte, the cracks or pores which may form in the positive electrode 10 due to expansion and contraction during charge and discharge may be suppressed.

Therefore, according to the solid secondary battery 1 related to the present embodiment, the impact of charge/discharge processes on the positive electrode 10, in addition to the negative electrode 20, may be inhibited to the greatest extent. As a result, even when an external pressure is not applied to the solid secondary battery 1, cycle characteristics of the solid secondary battery 1 may be further improved.

During the charge/discharge processes of the solid secondary battery 1, the external pressure applied to the solid secondary battery 1 using a compression jig, may be about 1 MPa or less, about 1 kilopascal (KPa) or less, about 100 Pa or less, about 10 Pa or less, or about 1 Pa or less. During the charge/discharge processes of the solid secondary battery 1, the external pressure applied on the solid secondary battery 1 may be, for example, more than 0 pascal (Pa) to about 1 MPa, about 0.01 Pa to about 1 KPa, about 0.1 Pa to about 100 Pa, about 0.2 Pa to about 10 Pa, or about 0.5 Pa to about 1 Pa, wherein the endpoints of the foregoing ranges are independently combinable. When a low pressure of 1 MPa or less is applied to the solid secondary battery 1, cycle characteristics of the solid secondary battery 1 may be further improved. Compression, e.g., pressure applied by using a compression jig, may not be applied to the solid secondary battery 1. Thus, in the disclosed battery a compression jig may be omitted.

During charge/discharge processes of the solid secondary battery 1, a temperature of the solid secondary battery 1 may be, for example, about 40° C. or less, about 35° C. or less, about 30° C. or less, or about 25° C. or less. During charge/discharge processes of the solid secondary battery 1, the temperature of the solid secondary battery 1 may be, for example, about 0° C. to about 40° C., about 5° C. to about 35° C., about 10° C. to about 30° C., or about 15° C. to about 25° C., wherein the endpoints of the foregoing ranges are independently combinable. When the solid secondary battery 1 operates at a low temperature of about 40° C. or less, cycle characteristics of the solid secondary battery 1 may be further improved.

A solid secondary battery module includes: a solid secondary battery stack in which a plurality of the solid secondary batteries is stacked; and a support member disposed on one side or both sides of the solid secondary battery stack, wherein a pressure the support member applies to the solid secondary battery stack is about 1 MPa or less. In an aspect, the compression is in a thickness direction. The solid secondary battery stack may be stacked in a thickness direction of the solid secondary battery. A pressure applied by the support member to the solid secondary battery stack may be, for example, about 1 MPa or less, about 1 KPa or less, about 100 Pa or less, about 10 Pa or less, or about 1 Pa or less, wherein the endpoints of the foregoing ranges are independently combinable. A pressure applied by the support member to the solid secondary battery stack may be, for example, more than about 0 Pa to about 1 MPa, about 0.01 Pa to about 1 KPa, about 0.05 Pa to about 100 Pa, about 0.1 Pa to about 10 Pa, or about 0.5 Pa to about 1 Pa, wherein the endpoints of the foregoing ranges are independently combinable. The support member may not apply compression or a pressure to the solid secondary battery stack. The support member may be a plate, a case, or a frame for fixing a plurality of solid secondary batteries, but is not limited thereto, and any suitable tool that is used as a support member in the art may be used.

The solid electrolyte is not limited to include the above-described oxide solid electrolyte, and may include any suitable solid electrolyte, or binder.

In addition, the solid electrolyte layer is not limited to include the disclosed oxide solid electrolyte, and may include a sulfide solid electrolyte. For the sulfide solid electrolyte included in the solid electrolyte, the above-disclosed the sulfide solid electrolyte for the positive electrode may be used.

In the embodiment, a case of the solid secondary battery in which the positive electrode contains an ionic liquid electrolyte is also disclosed, and the present disclosure may be applied to any solid secondary battery having a solid negative electrode and a solid electrolyte. For example, the present disclosure may be applied to the solid secondary battery containing a liquid electrolyte in addition to the solid electrolyte in the all-solid secondary battery.

Referring to the attached drawings, preferred embodiments of the present disclosure are described in detail, however, the present disclosure is not limited to such examples. It will be understood by those of ordinary skill in the art that a variety of variations and modifications are included in the scope of that described and in the appended claims.

### Examples

Hereinafter, the solid secondary battery related to the present disclosure will be described in more detail with examples, but the present disclosure is not limited to these examples.

### Preparation of Solid Secondary Battery

### (Preparation of Negative Electrode)

For each of examples and comparative examples, a thin film of mixed particles of silver (Ag) and carbon or a thin film of mixed particles of silicon (Si) and carbon were prepared as negative active materials.

Silver (Ag) or silicon (Si) having a particle diameter of about 60 nm were used, and for carbon, any one of Asahi Carbon's carbon black (CB-1, CB-2, CB-3, CB-4, CB-5), Denka's acetylene black (AB), and Cabot's carbon black (LITX50, LITX200) was used. 6 grams (g) of carbon and 2 g of silver particles were put into a container and an N-methylpyrrolidone (NMP) solution including a binder was added dropwise and stirred, to prepare slurry. On a negative electrode current collector made of 10 μm of stainless steel (SUS), the slurry was applied using a blade coater, and dried in the air at 80° C. for about 20 minutes, and vacuum dried at 100° C. for about 12 hours, to prepare a negative electrode. As a binder, polyvinylidene fluoride (PVDF) was used. For each of examples and comparative examples, compositions of the negative active material layer are shown in Table 1 below. The ratios described in the column for compositions of a negative active material layer in Table 1 refer to weight ratio of each component. In addition, for carbon black used in these examples, carbon black sold from the same manufacturer that has an average primary particle diameter and a D/G ratio as described in the examples, although the product number may not be exactly the same, show the same experimental results.

In addition, an average primary particle diameter of the particulate carbon was measured using a transmission electron microscope (TEM) and calculated according to ASTM D3849-13.

### (Preparation of Solid Electrolyte)

For the solid electrolyte, a vacuum dried pellet (Toshima manufacturing Co., Li₇La₃Zr₂₋ₓTaₓO₁₂ (0<x<2, LLZ-Ta) of an oxide solid electrolyte (LLZO) phosphorous-treated for 1 minute with 5 moles per liter (moVL) of phosphorous was used.

### (Preparation of Positive Electrode)

LiNi_{0.8}Co_{0.15}Al_{0.05}O₂ (NCA) was used as a positive active material, carbon nano tube (CNT) and carbon black (CB) were used as conductors, and a PVDF binder was used as a binder, and the materials were mixed in a mass ratio of positive active material:CNT:CB:PVDF=98:0.5:0.5:1, and NMP was added in the same manner as in preparing the negative electrode and was stirred, to prepare a slurry. The prepared slurry was applied on an aluminum current collector foil using a blade coater, and dried in the air at 80° C. for about 20 minutes, and vacuum dried at 100° C. for about 12 hours. After drying, a liquid electrolyte containing an ionic liquid was impregnated to the slurry to prepare a positive electrode.

2 M of lithium bis (fluorosulfonyl)imide (LiFSI) was added to N-propyl-N-methylpyrrolidinium bis(fluoromethanesulfonyl) imide (Pyr13FSI), which is an ionic liquid, to be used as a liquid electrolyte.

### (Preparation of Solid Secondary Battery)

The positive electrode, solid electrolyte, and negative electrode prepared in this way were stacked in the stated order, sealed with a laminate film in a vacuum and treated for 30 minutes at 490 MPa, to prepare a solid secondary battery.

Each of a part of the positive electrode and a part of the negative electrode was exposed out of the laminate film without damaging the vacuum of the battery, and the exposed parts were terminals of the positive electrode and the negative electrode, respectively.

### Measurement of Film Strength of Negative Active Material Layer

A film strength of a negative active material layer was measured by measuring a shear strength (expected shear strength) using a surface and interfacial characterization analysis system (SAICAS) manufactured by Daipla Wintes Co., Ltd. Measurement results are shown in Table 1. Specifically, using a diamond blade, the negative active material layer was notch cut while measuring a shear strength, and thus a film strength was measured. Specific experimental conditions were as follows.

Cutting blade specifications: sweepback angle 10°, blade angle 60°, structure angle 20°, blade width 1 mm.

Movement conditions of cutting blade: horizontally 2 micrometers per second (μm/sec), vertically 0.2 μm/sec.

### Evaluation of Charge/Discharge Characteristics

Charge/discharge characteristics of the all-solid secondary battery prepared in this way were evaluated under the following conditions.

The measurement was performed after the solid secondary battery was put into a thermostatic bath at 25° C. Charging to 4.25 V and discharging to 2.85 V were performed at each current density. In addition, such charge/discharge tests were carried out without applying any external pressure to the solid secondary battery. In the example, in order to investigate discharge rate characteristics, a discharge capacity at the second cycle at a current density of 0.5 milliampere per square centimeters (mA/cm²) was measured. In addition, in order to evaluate cycle characteristics, a discharge capacity at the 200th cycle was measured, and a proportion of the discharge capacity at the 200th cycle was calculated using 6.3 mAh/cm² as a rated capacity, set to be 100 percent (%). Measurement results are shown in Table 1.

TABLE 1

| | | | Average primary | | | | | |
|---|---|---|---|---|---|---|---|---|
| | | | particle diameter | | | | | |
| | | | of carbon-based | Ag | Carbon | Film | Discharge | |
| | Composition of negative | | material | content | content | strength | capacity | Lifespan |
| | active material | D/G | [nm] | [mg/cm²] | [mg/cm²] | [MPa] | [mAh/cm²] | [MPa] |
| Example 1 | Ag/CB-1/PVDF = 25/75/10 | 1.8 | 35 | 0.22 | 0.65 | 50 | 5.65 | 65.8 |
| Example 2 | Ag/CB-2/PVDF = 25/75/10 | 2.1 | 38 | 0.23 | 0.69 | 78 | 5.79 | 70.7 |
| Example 3 | Ag/CB-2/PVDF = 25/75/10 | 2.1 | 38 | 0.11 | 0.34 | 78 | 6.09 | 73.3 |
| Example 4 | Ag/CB-2/PVDF = 40/60/10 | 2.1 | 38 | 0.33 | 0.50 | 91 | 5.84 | 61.6 |
| Example 5 | Ag/CB-2/PVDF = 40/60/10 | 2.1 | 38 | 0.18 | 0.27 | 91 | 6.25 | 76.5 |
| Example 6 | Ag/CB-2/PVDF = 60/40/10 | 2.1 | 38 | 0.23 | 0.15 | 132 | 6.24 | 80.8 |
| Comparative | Ag/CB-3/PVDF = 25/75/10 | 0.7 | 38 | 0.23 | 0.68 | 12 | 0.78 | 4.1 |
| Example 1 | | | | | | | | |
| Comparative | Ag/CB-4/PVDF = 25/75/3.5 | 2.3 | 76 | 0.24 | 0.73 | 25 | 3.42 | 21.2 |
| Example 2 | | | | | | | | |
| Comparative | Ag/LITX200/PVDF = 25/75/10 | 1.8 | 30~40 | 0.22 | 0.67 | 39 | 5.84 | 48.3 |
| Example 3 | | | | | | | | |
| Comparative | Ag/CB-5/PVDF = 25/75/10 | 2 | 40 | 0.22 | 0.67 | 44 | 3.98 | 53.2 |
| Example 4 | | | | | | | | |
| Comparative | Ag/AB/PVDF = 25/75/10 | 1 | 32 | 0.23 | 0.68 | 44 | 2.51 | 35.1 |
| Example 5 | | | | | | | | |
| Comparative | Ag/LITX50/PVDF = 25/75/10 | 1.1 | 30~40 | 0.25 | 0.74 | 49 | 1.70 | 19.7 |
| Example 6 | | | | | | | | |

From the results of Table 1, for Examples 1 to 6 in which film strengths of the negative active material layer was in a range of 50 MPa to 250 MPa, even when an external pressure is not applied, it was confirmed that a high discharge rate characteristic and high cycle characteristics may be achieved at the same time.

From these results of the examples and comparative examples, when film strengths of the negative active material layer are in the range of 50 MPa to 250 MPa, even when an external pressure is not applied, it was confirmed that damage of the negative electrode layer due to expansion and contraction of the negative electrode layer during charge and discharge may be suppressed.

In addition, using a particulate carbon having an area ratio (D/G) of 1.0 to 3.0 (that is, having a relatively low crystallinity) and having a relatively small particle diameter with an average primary particle diameter of 5 nm to 55 nm, isotropicity of Li-ion transport in the carbon-based material (e.g., the particulate carbon) was increased, and movement of Li-ions became easier in the negative active material layer, and thus, rate characteristics were improved.

In addition, from the result of Example 4, it was confirmed that an appropriate content of a negative active material per unit area of the negative active material layer was 0.1 mg/cm² to 0.3 mg/cm².

In addition, from the results of Comparative Examples 5 and 6, it was confirmed that an appropriate range of a ratio of peak areas D/G for the carbon-based material is 1.5 or greater.

According to a solid secondary battery related to the present disclosure, for a solid secondary battery having a volume change when charged or discharged, like the solid secondary battery that deposits lithium in the negative electrode by charging beyond the initial charge capacity of the negative active material layer, without applying an external pressure using a compression jig and the like, charge/discharge processes may be made possible.

Thus, it is possible to simplify or miniaturize a compression jig, or to configure a battery module that does not have a compression jig, and an overall energy density of the battery module may be significantly improved.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A solid secondary battery comprising:
a positive electrode;
a negative electrode; and
a solid electrolyte disposed between the positive electrode and the negative electrode,
wherein the negative electrode comprises
a negative electrode current collector, and
a negative active material layer between the negative electrode current collector and the solid electrolyte,
the negative active material layer comprises a particulate carbon and a negative active material that forms an alloy or a compound with lithium,
a content of the negative active material per unit area of the negative active material layer is about 0.01 milligram per square centimeter to about 1 milligram per square centimeter, and
a film strength of the negative active material layer is about 50 megapascals to about 250 megapascals.

2. The solid secondary battery of claim 1, wherein a content of the particulate carbon per unit area of the negative active material layer is about 0.01 milligram per square centimeter to about 1 milligram per square centimeter.

3. The solid secondary battery of claim 1, wherein a ratio of a peak area of a D-band to a peak area of a G-band in a Raman spectrum of the particulate carbon is about 1 to about 3.

4. The solid secondary battery of claim 1, wherein a ratio of a content of the negative active material per unit area of the negative active material layer to a content of the particulate carbon per unit area of the negative active material layer is about 0.3 to about 5.

5. The solid secondary battery of claim 1, wherein an average primary particle diameter of the particulate carbon is about 5 nanometers to about 55 nanometers.

6. The solid secondary battery of claim 1, wherein the negative active material comprises an alloy-forming element comprising gold, platinum, palladium, silicon, silver, aluminum, bismuth, tin, zinc, or a combination thereof.

7. The solid secondary battery of claim 1, wherein the negative active material is in a particulate form, and a particle diameter of the negative active material is about 10 nanometers to about 4 micrometers.

8. The solid secondary battery of claim 1, wherein the negative active material layer further comprises a binder, and the binder is polyvinylidene fluoride, styrene-butadiene rubber, polytetrafluoroethylene, polyethylene, a vinylidene fluoride-hexafluoropropylene copolymer, polyacrylonitrile, polymethyl methacrylate, or a combination thereof.

9. The solid secondary battery of claim 8, wherein a content of the binder is about 1 weight percent to about 20 weight percent, with respect to a total weight of the negative active material layer.

10. The solid secondary battery of claim 1, wherein the positive electrode comprises a positive active material layer, and the negative electrode comprises a negative active material layer, and
a ratio of a charge capacity of the negative active material layer to a charge capacity of the positive active material layer satisfies Equation 1:
0.01<b/a<0.5 (1),
wherein
a is a charge capacity of a positive active material layer, and
b is a charge capacity of a negative active material layer.

11. The solid secondary battery of claim 1, wherein a thickness of the negative active material layer is about 1 micrometer to about 20 micrometers.

12. The solid secondary battery of claim 1, wherein the solid electrolyte comprises an oxide solid electrolyte.

13. The solid secondary battery of claim 12, wherein the oxide solid electrolyte comprises Li_{1+x+y}AlₓTi₂₋ₓSi_{y}P_{3-y}O₁₂ wherein 0<x<2 and 0≤y<3, BaTiO₃, Pb(Zr₁₋ₓTiₓ)O₃ wherein 0≤x≤1, Pb₁₋ₓLaₓZr_{1-y}Ti_{y}O₃ wherein 0≤x<1 and 0≤y<1, Pb(Mg_{1/3}Nb_{2/3})O₃—PbTiO₃, HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ wherein 0<x<2 and 0<y<3, LiₓAl_{y}Ti_{z}(PO₄)₃ wherein 0<x<2, 0<y<1, and 0<z<3, Li_{1+x+y}(Al₁₋ₚGaₚ)ₓ(Ti_{1-q}Ge_{q})₂₋ₓSi_{y}P_{3-y}O₁₂ wherein 0≤x≤1, 0≤y≤1, 0≤p≤1, and 0≤q≤1, LiₓLa_{y}TiO₃ wherein 0<x<2 and 0<y<3, Li₂O, LiOH, Li₂CO₃, LiAlO₂, Li₂O—Al₂O₃—SiO₂—P₂O₅—TiO₂—GeO₂, Li₃₊ₓLa₃M₂O₁₂ wherein M is Te, Nb, Zr, or a combination thereof, and 0≤x≤10, Li₇La₃Zr₂₋ₓTaₓO₁₂ wherein 0<x<2, or a combination thereof.

14. The solid secondary battery of claim 12, wherein the oxide solid electrolyte comprises Li_{1.3}Al_{0.3}Ti_{1.7}(PO₄)₃, Li_{0.34}La_{0.51}TiO_{2.94}, Li_{1.07}Al_{0.69}Ti_{1.46}(PO₄)₃, 50Li₄SiO₄-50Li₂BO₃, 90Li₃BO₃-10Li₂SO₄, Li_{2.9}PO_{3.3}N_{0.46}, Li₇La₃Zr₂O₁₂, or a combination thereof.

15. The solid secondary battery of claim 1, wherein the solid electrolyte comprises a binder.

16. The solid secondary battery of claim 1, wherein an arithmetic average height of a surface of the solid electrolyte in contact with the negative active material layer is about 0.05 micrometer to about 0.6 micrometer.

17. The solid secondary battery of claim 1, further comprising a lithium deposition layer between the negative electrode current collector and the negative active material layer,
wherein the lithium deposition layer comprises lithium metal, a lithium alloy, or a combination thereof.

18. The solid secondary battery of claim 17, wherein a thickness of the lithium deposition layer is about 10 micrometers to about 60 micrometers.

19. The solid secondary battery of claim 1, wherein the positive electrode comprises a positive active material layer, and the negative electrode comprises a negative active material layer, and
the positive active material comprises lithium cobalt oxide, lithium nickel oxide, lithium nickel cobalt oxide, lithium nickel cobalt aluminum oxide, lithium nickel cobalt manganate, lithium manganate, lithium iron phosphate, nickel sulfide, copper sulfide, lithium sulfide, sulfur, iron oxide, vanadium oxide, or combination thereof.

20. The solid secondary battery of claim 19, wherein the positive active material is a lithium transition metal oxide having a layered structure represented by at least one of Formulae 1 to 6:
LiₐNiₓCo_{y}M_{z}O_{2-b}A_{b}, Formula 1
wherein in Formula 1,
1.0≤a≤1.2, 0≤b≤0.2, 0.3≤x<1, 0<y≤0.3, 0<z≤0.3, and x+y+z=1,
M is Mn, Nb, V, Mg, Ga, Si, W, Mo, Fe, Cr, Cu, Zn, Ti, Al, or a combination thereof, and
A is F, S, Cl, Br, or a combination thereof;
LiNiₓCo_{y}Mn_{z}O₂, Formula 2
LiNiₓCo_{y}Al_{z}O₂, Formula 3
wherein in Formulae 2 or 3, x, y, and z are each independently 0.3≤x≤0.95, 0<y≤0.2, 0<z≤0.2, and x+y+z=1;
LiNiₓCo_{y}MnᵥAl_{w}O₂, Formula 4
wherein in Formula 4, 0.3≤x≤0.95, 0<y≤0.2, 0<v≤0.2, 0<w≤0.2, and x+y+v+w=1;
LiₐCOₓM_{y}O_{2-b}A_{b}, Formula 5
wherein in Formula 5,
1.0≤a≤1.2, 0≤b≤0.2, 0.9≤x≤1, 0≤y≤0.1, and x+y=1,
M is Mn, Nb, V, Mg, Ga, Si, tungsten (W, Mo, Fe, Cr, Cu, Zn, Ti, Al, or a combination thereof, and
A is F, S, Cl, Br, or a combination thereof; or
LiNiₓMn_{z}O₂, Formula 6
wherein in Formula 6, 0.3≤x<1, 0<z≤0.3, and x+z=1.

21. The solid secondary battery of claim 1, wherein the positive electrode comprises a positive active material layer, and the positive active material layer further comprises a second solid electrolyte, wherein the solid electrolyte and the second solid electrolyte are the same or different.

22. The solid secondary battery of claim 21, wherein the second solid electrolyte comprises an oxide solid electrolyte, a sulfide solid electrolyte, or a combination thereof.

23. The solid secondary battery of claim 1, wherein the positive electrode comprises a positive active material layer, and the positive active material layer comprises a liquid electrolyte, and
the negative electrode and the solid electrolyte are each free of the liquid electrolyte.

24. The solid secondary battery of claim 23, wherein the liquid electrolyte comprises a lithium salt, an ionic liquid, a polymer ionic liquid, or a combination thereof.

25. The solid secondary battery of claim 1, wherein a compression applied to the solid secondary battery during charge and discharge is about 1 megapascal or less, and a temperature of the solid secondary battery during charge and discharge is about 40° C. or less.

26. A solid secondary battery module comprising:
a solid secondary battery stack comprising a plurality of the solid secondary battery of claim 1; and
a support member disposed on a side of the solid secondary battery stack, wherein a compression applied by the support member to the solid secondary battery stack is about 1 megapascal or less.

27. A method of charging the solid secondary battery of claim 1, wherein the solid secondary battery is charged beyond a charge capacity of the negative active material layer.

28. The method of charging a solid secondary battery of claim 29, wherein the solid secondary battery is charged such that a thickness of a lithium deposition layer deposited in the negative electrode is about 10 micrometers to about 60 micrometers.
